(19) United States
(12) Patent Application Publication
(10) Pub. No.: US 2026/0365874 A1
(43) Pub. Date: Nov. 19, 2026

(54) Super-High Flexural Modulus Polyurethane-Based Coatings

(71) Applicant: Henry Company, LLC, Kimberton, PA (US)

(72) Inventors: Todd Volz, Kimberton, PA (US); Hany Botros, Riverside, CA (US)

(21) Appl. No.: 19/652,736

(22) Filed: Apr. 20, 2026

Related U.S. Application Data
(60) Provisional application No. 63/790,953, filed on Apr. 18, 2025.

(51) Int. Cl. C09D 175/08; C08G 18/20; C08G 18/22; C08G 18/32; C08G 18/48; C08G 18/66; C08G 18/76; F16L 9/14

(52) U.S. Cl. CPC C09D 175/08; C08G 18/2027; C08G 18/227; C08G 18/3206; C08G 18/3284; C08G 18/4829; C08G 18/6688; C08G 18/7671; F16L 9/14

(57) ABSTRACT

Disclosed herein are high-performing polyurethane coatings with a super-high flex modulus for protecting pipes and conduits, methods for preparing such coatings and applying those coating to pipes and conduits. The disclosed polyurethane coatings provide superior mechanical strength, flexibility, and environmental resistance while reducing coating thickness. It is particularly well-suited for industries requiring lightweight, durable, and efficient protective solutions for pipelines.

### CROSS REFERENCE TO RELATED APPLICATIONS

The present application hereby claims the benefit of the provisional patent application of the same title, U.S. Application No. 63/790,953, filed Apr. 18, 2025, the disclosure of which is herein incorporated by reference in its entirety.

### FIELD

The disclosed technology relates to polyurethane coatings for protecting pipes and pipelines and methods for preparing such coatings and applying coatings to pipes and pipelines.

### BACKGROUND

Pipelines play a crucial role in transportation systems across industries, including oil, gas, water, and chemicals. These systems are exposed to harsh environments, including mechanical stress, chemical corrosion, and extreme weather conditions, which necessitate durable protective coatings. Traditional coatings often lack the necessary flexibility, durability, or thinness to provide optimal performance in demanding applications.

Pipes are crucial infrastructure components made from various materials including corrugated steel, heavy duty corrugated plastic, or reinforced concrete. Pipes used to divert creek water, manage stormwater, and ensure drainage in various environmental and urban settings. Over time, these pipes are exposed to environmental stressors such as water flow, soil movements, and chemical reactions that can lead to corrosion, cracking, and failure. These factors are exacerbated in conditions where the culvert pipes experience high flexural forces due to environmental stresses such as ground shifts, pressure from surrounding soil, or external impact loads.

Currently, high flexural modulus polyurethane coatings applied to culvert pipes serve primarily to protect against corrosion and abrasion. However existing materials often fail to provide adequate resistance to flexural deformation, which is critical in preserving the pipe's structural integrity and functionality. Thus, there is a need for a highly durable, flexible, and resistant coating that can withstand significant Flexural stress while maintaining optimal corrosion resistance.

### SUMMARY

Disclosed herein are high-performing polyurethane (“PU”) coatings with a super-high flex modulus for protecting pipes, the method for preparing such coatings and applying those coating to the pipes. In one embodiment, the ensures superior mechanical strength, flexibility, and environmental resistance while reducing coating thickness. It is particularly well-suited for industries requiring lightweight, durable, and efficient protective solutions for pipelines. These high-performing polyurethane coatings with a super-high flex modulus can be characterized as 100% polyurethane coatings that are suitable for rehabilitation of pipes, pipelines and any of a variety of conduits. This invention further relates to polyurethane spray elastomer coatings.

Disclosed herein are compositions for polyurethane coating for the inner surface of pipes, wherein the composition is prepared from components comprising a polyol component, an isocyanate component that reacts with polyol to form a tough, cross-linked polyurethane structure, and two or more cross-linking agents to increase the flexural modulus of the resulting coating, wherein the total of —OH groups on the two or more cross-linking agents is six or more.

Also disclosed are polymeric compositions and coatings prepared by reacting compositions for polyurethane coating for the inner surface of pipes, wherein the composition is prepared from components comprising a polyol component, an isocyanate component that reacts with polyol to form a tough, cross-linked polyurethane structure, and two or more cross-linking agents to increase the flexural modulus of the resulting coating, wherein the total of —OH groups on the two or more cross-linking agents is six or more.

Also disclosed are methods for applying a polyurethane coating to an inner surface of a pipe or conduit, comprising mixing polyol and isocyanate components to form a mixture, applying the mixture to the inner surface, and allowing the coating to cure to form a durable, seamless protective layer.

Also disclosed are polyurethane coatings as recited in claims above, wherein the PU with the high flexural modulus of at least (400,000 PSI), provides resistance to bending and deformation under environmental stresses.

Also disclosed are pipes or conduits coated fully or partially on the inside with the compositions as described herein.

Also disclosed are compositions for preparing polyurethane coatings for inner surfaces of pipes, wherein the compositions are prepared from a B-side component and an A-side component, wherein the B-side component comprises a sucrose-based polyol having a molecular weight in the range of from about 700 to 800, or about 732, an ethylene diamine tetrol having a MW in the range of from about 200 to 400, or about 290 g/mol, an oxypropylated aliphatic amine cross-linker, diethylene glycol as a chain extender, a polyether diol chain extender, an aromatic initiator-based polyol, one or more catalysts, and an anti-foaming agent, wherein the A-side component comprises a polymeric MDI having a functionality in the range of from about 2.5 to about 3.0, or about 2.7.

Also disclosed are cured polyurethane coatings prepared from the compositions, as described herein, wherein the cured coating has a Shore D hardness in the range of from about 80 to about 90, or about 84.

Also disclosed are methods for preparing a B-side component for a high flexural modulus polyurethane coating, comprising adding to a clean vessel a sucrose-based polyol, a rheology additive, a polyether diol chain extender, an aromatic initiator-based polyol, an ethylene diamine tetrol, diethylene glycol, an oxypropylated aliphatic amine cross-linker, and an anti-foaming agent, mixing the components until homogeneous, adding one or more catalysts to the homogeneous mixture, adding a moisture scavenger to the mixture, and mixing and vacuuming the polymeric composition.

Also disclosed are pipe and conduit rehabilitation systems, comprising an A-side component comprising an isocyanate component and a B-side component comprising a polyol component and two or more cross-linking agents, wherein a total of —OH groups on the two or more cross-linking agents is six or more, and wherein the A-side component and the B-side component are configured to be mixed to polymerize and form a cured polyurethane coating on an inner surface of an installed pipe or conduit, wherein the cured polyurethane coating has a flexural modulus in a range of from about 400 KPSI to about 800 KPSI.

The general description and the following detailed description are exemplary and explanatory only and are not restrictive of the invention, as defined in the appended claims. Other aspects of the present invention will be apparent to those skilled in the art in view of the detailed description of the invention as provided herein.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

This invention relates to polyurethane formulations engineered to have a super high flex modulus for protecting pipes and conduits, for example, culvert pipes, using a thinner layer coating. It allows for increased flexibility and durability under mechanical and thermal stress. It also gives a lower overall cost by reducing material usage and application time while maintaining or exceeding the performance of traditional thicker coatings.

A culvert pipe is a tunnel structure, typically made of concrete, steel, or plastic, used to allow water to flow under roads, railways, or driveways. It serves as a, passage for small streams or drainage ditches, preventing erosion and flooding without hindering traffic. Common types include round pipes, box, and arch designs. Other types of conduits can be suitably coated according to the compositions and methods described herein.

In one embodiment, this invention pertains to a thinner high-performing polyurethane coating with a super-high flex modulus for protecting pipes, the method for preparing such coatings and applying those coating to the pipes. In one embodiment, the invention ensures superior mechanical strength, flexibility, and environmental resistance while reducing coating thickness. It is particularly well-suited for industries requiring lightweight, durable, and efficient protective solutions for pipelines.

This advanced polyurethane coating technology is applicable to a wide range of conduits and pipe systems across various sectors. Potential candidates for coating include: Metal pipes, such as corrugated steel pipes used for stormwater management, drainage, and creek diversion. Heavy-duty corrugated plastic pipes commonly utilized in urban infrastructure, agricultural irrigation, and sewage systems. Reinforced concrete pipes found in municipal water distribution, culverts, and large-scale drainage projects. Oil and gas pipelines that require robust protection against mechanical stress, chemical corrosion, and extreme environmental conditions. Chemical transport conduits, where resistance to aggressive substances and flexural fatigue is essential. Water supply and wastewater pipes exposed to varying flow rates, soil movement, and external impact loads. Industrial process pipes and conduits, including those used in manufacturing plants and refineries. Culvert pipes in environmental and urban settings, where high flexural forces and corrosion are prevalent. The coating's combination of thinness, flexibility, and durability makes it suitable for rehabilitating both new and aging conduits of diverse materials and applications, ensuring extended service life and enhanced performance under challenging conditions.

The composition is designed to be non-toxic, with minimal environmental impact during application and throughout its lifecycle. It provides an environmentally responsible solution for pipes protection.

The invention comprises a composition of specially designed polyurethane polymers, isocyanate, cross-linking agents, and additives that work synergistically to provide the coating with excellent resistance to flexural fatigue, chemical attack, and abrasion.

### Polyol Component

The polyol component is selected to provide the necessary flexibility and durability to the coating. A surprising result was obtained in that a blend of aliphatic or aromatic polyols with varying molecular weights provided super high flexibility and resistance to cracking.

In one embodiment, the isocyanate component is typically a modified diisocyanate, which is chosen to react with the polyol blend to form a tough, highly cross-linked structure that enhance the coating's resistance to bending, cracking, and deformation under flexural stress. The isocyanate's properties are critical in achieving the high flexural modulus while maintain the necessary chemical and thermal stability.

In one embodiment of the invention, a combination of multiple cross-linking agents was specifically incorporated into the formulation to create an extensive network of bonds between polymer chains, giving the final cured coating a super-high flexural modulus. Without wishing to be bound by any theory, it is speculated that the enhanced network of bonds allows the coating to withstand significant flexural forces without cracking or degrading.

One embodiment provides a composition for polyurethane coating for the inner surface of pipes, wherein the composition is prepared from components comprising: a polyol component; an isocyanate component that reacts with polyol to form a tough, cross-linked polyurethane structure; and two or more cross-linking agents to increase the flexural modulus of the resulting coating, wherein the total of —OH groups on the two or more cross-linking agents is six or more.

In further embodiments of the composition, the cross-linking agents include amine-based polyols or polyfunctional alcohols with three or more OH groups. In further embodiments, the cross-linking agents are derived from ethylenediamine or similar amines through alkoxylation, for example, with propylene oxide and/or ethylene oxide. In further embodiments, the cross-linking agent is at least any two of N,N,N′,N′-tetrakis(2-hydroxypropyl)ethylenediamine (Quadrol, EDTP); N,N,N′,N′-tetrakis(2-hydroxyethyl)ethylenediamine (THEED); triethanolamine; (TEA) diethanolamine (DEA); pentaerythritol; ethoxylated pentaerythritol; sorbitol; propoxylated ethylenediamine; trimethylolpropane (TMP); and ethoxylated trimethylolpropane.

In further embodiments of the composition, the polyol component comprises a sucrose-based polyol having a molecular weight in the range of from about 500 to about 1000, or about 732. In further embodiments, the sucrose-based polyol has a functionality of from about 3 to about 6, or about 4.5. In further embodiments, the polyol component comprises a sucrose-based polyol present in an amount in the range of from about 25% to about 55% by weight of the composition. In further embodiments, the sucrose-based polyol is present in an amount in the range of from about 27% to about 35% by weight of the composition.

In further embodiments of the composition, the two or more cross-linking agents comprise a 292 MW ethylene diamine tetrol and Poly-G 37-600. In further embodiments, the 292 MW ethylene diamine tetrol is N,N,N′,N′-tetrakis(2-hydroxypropyl)ethylenediamine. In further embodiments, the 292 MW ethylene diamine tetrol is present in an amount in the range of from about 7% to about 13% by weight of the composition. In further embodiments, the 292 MW ethylene diamine tetrol is present in an amount of about 12% by weight of the composition. In further embodiments, the Poly-G 37-600 is present in an amount in the range of from about 10% to about 30% by weight of the composition. In further embodiments, the Poly-G 37-600 is present in an amount in the range of from about 10% to 20%, or from about 14% to about 15% by weight, of the composition.

In further embodiments of the composition, the composition further comprises a chain extender. In further embodiments, the chain extender comprises diethylene glycol. In further embodiments, the diethylene glycol is present in an amount in the range of from about 10% to about 16% by weight of the composition. In further embodiments, the diethylene glycol is present in an amount of about 13% to about 15% by weight of the composition. In further embodiments, the composition further comprises a polyether diol chain extender having a molecular weight in the range of from about 200 to about 600, or about 425 g/mol. In further embodiments, the polyether diol chain extender comprises Voranol 220-260 present in an amount in the range of from about 13% to about 20% by weight of the composition. In further embodiments, the composition further comprises an aromatic initiator-based polyol having a hydroxyl number in the range of from about 395 to about 415. In further embodiments, the aromatic initiator-based polyol comprises Pluracol 1578 present in an amount in the range of from about 10% to about 15% by weight of the composition.

In further embodiments of the composition, the composition is a 100% solids polyurethane composition. In further embodiments, the cured coating has a thickness in the range of from about 50 mils to about 500 mils. In further embodiments, the composition is formulated as a spray elastomer coating.

One embodiment provides a polymeric composition prepared by reacting the compositions as described herein. In further embodiments, the polymeric composition is characterized as having a flexural modulus in the range of from 400 KPSI and 800 KPSI. In further embodiments, the polymeric composition further comprises one or more additives to enhance chemical stability, chemical resistance, and abrasion resistance as described herein. In further embodiments, the flexural modulus is in the range of from about 400 KPSI to 500 KPSI.

One embodiment provides a method for applying a polyurethane coating to an inner surface of a pipe or conduit, comprising: mixing polyol and isocyanate components to form a mixture; applying the mixture to the inner surface; and allowing the coating to cure to form a durable, seamless protective layer. In further embodiments of the method, the polyurethane composition is as recited in claims 5-7. In further embodiments, the coating is applied at a thickness that is reduced by at least 25% compared to conventional polyurethane coatings while maintaining equivalent or superior flexural performance. In further embodiments, the step of applying the mixture to the inner surface of the pipe or conduit uses manual or robotic 1:1 plural high-pressure spray equipment. In further embodiments, the mixture comprises: a polyol component; an isocyanate component that reacts with polyol to form a tough, cross-linked polyurethane structure; and two or more cross-linking agents to increase the flexural modulus of the resulting coating, wherein the total of —OH groups on the two or more cross-linking agents is six or more.

One embodiment provides a polyurethane coating as described herein, wherein the PU with the high flexural modulus of at least (400,000 PSI), provides resistance to bending and deformation under environmental stresses.

One embodiment provides a pipe or conduit coated fully or partially on the inside with the compositions as described herein. In further embodiments, the pipe or conduit is a culvert pipe.

One embodiment provides a composition for polyurethane coating for inner surface of pipes, wherein the composition is prepared from a B-side component and an A-side component, wherein the B-side component comprises: a sucrose-based polyol having a molecular weight in the range of from about 700 to 800, or about 732; an ethylene diamine tetrol having a MW in the range of from about 200 to 400, or about 290 g/mol; an oxypropylated aliphatic amine cross-linker; diethylene glycol as a chain extender; a polyether diol chain extender; an aromatic initiator-based polyol; one or more catalysts; and an anti-foaming agent; wherein the A-side component comprises a polymeric MDI having a functionality in the range of from about 2.5 to about 3.0, or about 2.7.

In further embodiments of the composition, the B-side component and the A-side component are present in a ratio by volume of about 0.9 to 1.1, or about 1.1 to 0.9, or about 1:1. In further embodiments, the B-side component is present in an amount in the range of from about 45% to about 55% by weight of the total composition, or about 47% by weight. In further embodiments, the A-side component is present in an amount in the range of from about 45% to about 55% by weight of the total composition, or about 53% by weight. In further embodiments, the composition has an isocyanate index in the range of from about 0.85 to about 1.10, or about 0.94.

In further embodiments of the composition, the composition further comprises a rheology additive. In further embodiments, the rheology additive comprises BYK 410 present in an amount in the range of from about 0.5% to about 0.9% by weight of the B-side component. In further embodiments, the one or more catalysts comprise an organobismuth catalyst. In further embodiments, the organobismuth catalyst comprises bismuth (III) neodecanoate present in an amount in the range of from about 0.1% to about 0.21% by weight of the B-side component. In further embodiments, the one or more catalysts comprise an amine gelling catalyst. In further embodiments, the amine gelling catalyst comprises 1,2-dimethylimidazole present in an amount in the range of from about 1% to about 1.5% by weight of the B-side component. In further embodiments, the composition further comprises a moisture scavenger. In further embodiments, the moisture scavenger is present in an amount in the range of from about 3% to about 6% by weight of the B-side component. In further embodiments, the composition has a gel time at about 74 °F in the range of from about 10 seconds to about 40 seconds, or about 15 seconds. In further embodiments, the B-side component has a viscosity at about 75 °F in the range of from about 600 cps to about 900 cps, or about 870 cps. In further embodiments, the cured composition exhibits thermal stability under temperature variations encountered in underground pipe installations.

One embodiment provides a cured polyurethane coating prepared from the composition as described herein, wherein the cured coating has a Shore D hardness in the range of from about 80 to about 90, or about 84. In further embodiments, the cured polyurethane coating has an average flexural strength in the range of from about 9 KSI to about 16 KSI, or about 15 KSI. In further embodiments, the cured polyurethane coating provides resistance to flexural fatigue under cyclic loading conditions.

One embodiment provides a method for preparing a B-side component for a high flexural modulus polyurethane coating, comprising: adding to a clean vessel a sucrose-based polyol, a rheology additive, a polyether diol chain extender, an aromatic initiator-based polyol, an ethylene diamine tetrol, diethylene glycol, an oxypropylated aliphatic amine cross-linker, and an anti-foaming agent; mixing the components until homogeneous; adding one or more catalysts to the homogeneous mixture; adding a moisture scavenger to the mixture; and mixing and vacuuming the polymeric composition. In further embodiments, the sucrose-based polyol has a molecular weight in the range of from about 500 to about 1000, or about 732, and is present in an amount in the range of from about 25% to about 55% by weight in the mixture. In further embodiments, the ethylene diamine tetrol has a molecular weight of about 292 and is present in an amount in the range of from about 7% to about 13% by weight in the mixture. In further embodiments, the one or more catalysts comprise an organobismuth catalyst and an amine gelling catalyst. In further embodiments, the method further comprises combining the B-side component with an A-side component comprising a polymeric MDI at a ratio by volume of about 1:1 to form the polyurethane coating composition.

One embodiment provides a pipe and conduit rehabilitation system, comprising: an A-side component comprising an isocyanate component; and a B-side component comprising a polyol component and two or more cross-linking agents, wherein a total of —OH groups on the two or more cross-linking agents is six or more; and wherein the A-side component and the B-side component are configured to be mixed to polymerize and form a cured polyurethane coating on an inner surface of an installed pipe or conduit, wherein the cured polyurethane coating has a flexural modulus in a range of from about 400 KPSI to about 800 KPSI. In further embodiments, the pipe and conduit rehabilitation system further comprises a plural-component applicator configured to dispense the A-side component and the B-side component and mix the A-side component and the B-side component at a volumetric ratio of about 1:1 for application to the inner surface. In further embodiments, the pipe or conduit comprises a material selected from the group consisting of corrugated steel, corrugated plastic, and reinforced concrete. In further embodiments, the pipe or conduit has a diameter of at least 10 feet. In further embodiments, the cured polyurethane coating forms a seamless protective layer on the inner surface of the pipe or conduit.

TABLE I
Polyurethane coatings that have a Super High Flex. Modulus

| PRODUCT | Formula #1 | Formula #2 | Formula #3 | Formula #4 | Formula #5 | Final |
|---|---|---|---|---|---|---|
| 732 MW SUCROSE BASED POLYOL | 35.37 | 47.56 | 53.21 | 38.31 | 22.2 | 27.13 |
| 4800 MW EO CAPPED TRIOL | 15.26 | 13.35 | | | | |
| VORANOL 220-260 | 20 | 16 | 16 | | 16.1 | 13.1 |
| Pluracol 1578 | | | | | 12.26 | 10 |
| 292 MW ethylene diamine tetrol | | | 7.7 | 9.9 | 12.2 | 12.2 |
| DEG | 11.9 | 11 | 11 | 14.4 | 14.4 | 14.4 |
| POLYG 37-600 | 10.6 | 5 | 5 | 30.3 | 14.6 | 14.6 |
| RDF#1 | 0.05 | 0.04 | 0.04 | 0.04 | 0.04 | 0.02 |
| Coscat 83 | 0.02 | 0.05 | 0.05 | 0.05 | 0.2 | 0.15 |
| DABCO NE-310/JEFFCAT ZF-10 | 0.4 | | | | | |
| Toyocat DM-70 | 0.4 | 1 | 1 | 1 | 2 | 1.5 |
| P6000 (BURITH 5 MIX) | 6 | 6 | 6 | 6 | 6 | 6 |
| Byk 410 | | | | | | 0.9 |
| TOTAL | 100 | 100 | 100 | 100 | 100 | 100 |
| | 55 | 55 | 48 | 47 | 47 | 47 |
| A-SIDE | | | | | | |
| 2.7 Functional PMDI | 45 | 45 | 52 | 53 | 53 | 53 |
| I.I | 0.92 | 0.94 | 1.04 | 0.87 | 0.94 | 0.94 |
| Gel Time @74 F (SEC) | 31 | 31 | 36 | 33 | 13 | 15 |
| Viscosity@ 75 F (CPS) | 600 | 680 | 850 | 800 | 760 | 870 |
| Appearance | no | no | no | no | no | no |
| | separation | separation | separation | separation | separation | separation |
| Hardness (D) | 81 | 82 | 84 | 85 | 85 | 84 |
| Ave. Flex Strength [KSI] | 9.26 | 11.9 | 13.7 | 14.6 | 15.2 | 15.0 |
| Ave. Flex Modulus [KSI] | 286 | 356 | 436 | 441 | 449 | 493 |

Polyols and isocyanates are key ingredients in the production of polyurethanes, a versatile class of polymers used in a wide range of applications. Polyols, containing multiple hydroxyl (alcohol) groups, react with isocyanates, which have an isocyanate functional group (—NCO), to form urethane linkages and create long chains of polymers.

Polyols are molecules with multiple hydroxyl (—OH) groups. They serve as one of the two main building blocks for polyurethanes. Examples include polyether polyols (like poly(tetramethylene ether) glycol) and polyester polyols (like polyethylene adipate).

On the other hand, isocyanates are functional groups (—NCO) attached to a larger molecule. They react with the hydroxyl groups of polyols to form urethane linkages. Common examples include methylene diphenyl diisocyanate (MDI) and toluene diisocyanate (TDI).

When polyols and isocyanates are mixed, they undergo a chemical reaction where the isocyanate groups react with the hydroxyl groups to form urethane bonds. This process continues to link more and more molecules together, creating long chains of polymers. The resulting polyurethanes are versatile and used in a vast array of applications, including: Foams: Both flexible and rigid foams, used in cushioning, insulation, and packaging; Elastomers: Flexible materials like rubber and Spandex; Coatings: Protective and decorative coatings for various surfaces; Adhesives: Strong and durable adhesives for various materials; and Fibers: Spandex and other textile fibers.

This invention relates to a product used as pipe-lining for infrastructure rehabilitation of large pipes on the inside. These pipes are underground and can be massive. In the event the infrastructure starts leaking, the pipes can be dug up and the inside is sprayed with polyurethane (PU) and sealed, even using robots. Some of these pipes can have diameters as big as 10 ft or more.

This disclosure relates to a formulation for making polyurethane coatings that have a flex modulus of 400K-800 KPSI, which is about a 50-100% improvement compared to currently available PU coatings. The higher modulus assists with reducing the thickness of the rehabilitation (or the original) layers. Generally, a higher thickness translates to higher costs, in terms of material expenditure, downtime, and labor for repair and rehabilitation. Shorter maintenance windows and longer operating times for the pipes is desirable. The present technology addresses these issues by providing a surprisingly high flex modulus of the PU coatings to the inside lining of the pipes.

After extensive development work, the inventors unexpectedly found that cured polyurethane coatings having a flexural modulus greater than 400,000 psi can be produced by adjusting the relative concentrations of known polyurethane raw materials. In particular embodiments, the formulation employs multiple cross-linking agents to increase cross-link density and thereby increase flexural modulus. In certain embodiments, the resulting flexural modulus represents an improvement of about 50% over conventional polyurethane coating systems.

Test Methods Unless otherwise indicated, properties of the polyurethane compositions and cured coatings described herein (including, without limitation, flexural modulus and flexural strength, hardness, viscosity, gel time, abrasion resistance, adhesion, weathering resistance, and chemical resistance) can be measured using ASTM methodologies commonly used in the polyurethane coating industry, or equivalent test methods. By way of example, flexural modulus and flexural strength can be determined in accordance with ASTM D790 (or an equivalent flexural test), Shore D hardness can be determined in accordance with ASTM D2240, viscosity (e.g., reported in cps at a stated temperature) can be determined using an ASTM viscosity method suitable for the material (for example, ASTM D2196 and/or ASTM D4878, or an equivalent rotational viscometer methodology), gel time can be determined using an ASTM gel time methodology suitable for reactive polymer systems or coatings (or an equivalent method defining gel as loss of flow/working time under specified conditions), abrasion resistance can be determined in accordance with ASTM D4060, adhesion can be determined in accordance with ASTM D4541 and/or ASTM D3359, accelerated weathering can be determined in accordance with ASTM G154, and chemical resistance can be determined in accordance with ASTM D1308 and/or ASTM D543. Test specimen preparation, cure schedule, conditioning, temperature, and other test parameters can be selected in accordance with the applicable ASTM method and the intended end-use environment, and the use of equivalent standards and/or modified conditions is contemplated.

In one embodiment, Poly-G® 37-600 Polyol Poly-G®*37-600 polyol is a cross-linker for coatings and a hardener for elastomers. This product is also used in rigid foam systems to reduce viscosity and balance stoichiometry. Poly-G 37-600 polyol has a nominal molecular weight of 280 and is a stable liquid that is neither volatile nor corrosive.

The term “ethylene diamine tetrol” refers to a tetrafunctional polyol derived from ethylenediamine, commonly used as a cross-linking agent in polyurethane systems. Its full chemical name is N,N,N′,N′-tetrakis(2-hydroxypropyl)ethylenediamine, often abbreviated as quadrol or EDTP. This compound has four hydroxyl (OH) groups, making it a tetrol, and is widely used to enhance cross-link density, improving hardness, thermal stability, and chemical resistance in polyurethanes.

The term “I.I” In Table 1, “I.I” means Isocyanate Index (also commonly called the Index), is the ratio of isocyanate (NCO) equivalents to active hydrogen equivalents (mostly OH, sometimes also NH) in the B-side, typically expressed as: Index=(NCO equivalents/active H equivalents), thus, e.g., the I.I values (e.g., 0.92, 0.94, 1.04) indicate whether the formulation is isocyanate-lean (<1.0), stoichiometric (~1.0), or isocyanate-rich (>1.0).

The term “vacuuming” means applying vacuum (reduced pressure) to a fluid mixture, e.g., for vacuum degassing. Practically, after ingredients are mixed until homogeneous in, one pulls a vacuum on the vessel (often while gently stirring) to remove entrained air bubbles/foam introduced during mixing, reduce dissolved gases that can come out later and create bubbles, which can often help remove trace moisture/volatiles. This is generally useful for polyurethane reaction systems because moisture can react with isocyanate later and generate CO₂, causing bubbles/voids).

Generally, this disclosure relates to PU material with high flex modulus, wherein the starting ingredient of includes polyhydric alcohols. In one aspect, the technology relates to using two or more than two cross-linking agents, with a total of —OH groups of six or more than six.

### Related Cross-Linkers

Related cross-linking agents that can be used include other amine-based polyols or polyfunctional alcohols with three or more OH groups, often derived from ethylenediamine or similar amines through alkoxylation (e.g., with propylene oxide or ethylene oxide). These compounds provide similar tetrafunctional or higher cross-linking capabilities. Below is a list of N,N,N′,N′-tetrakis(2-hydroxypropyl)ethylenediamine and related cross-linking agents with triol or higher OH functionality suitable for polyurethanes:

### 1. N,N,N′,N′-Tetrakis(2-hydroxypropyl)ethylenediamine (Quadrol, EDTP)

OH Groups: 4 (tetrol)
Description: A tetrafunctional polyol derived from ethylenediamine reacted with propylene oxide. It provides high cross-link density, improving rigidity and durability.
Applications: Rigid foams, coatings, adhesives, elastomers.
Benefits: Enhances hardness and chemical resistance; amine backbone boosts reactivity.

### 2. N,N,N′,N′-Tetrakis(2-hydroxyethyl)ethylenediamine (THEED)

OH Groups: 4 (tetrol)
Description: Similar to quadrol but with hydroxyethyl groups (from ethylene oxide). Offers slightly higher hydrophilicity and flexibility.
Applications: Waterborne polyurethane dispersions, flexible coatings, sealants.
Benefits: Improved compatibility with aqueous systems.

### 3. Triethanolamine (TEA)

OH Groups: 3 (triol)
Description: An amine-based triol derived from ammonia and ethylene oxide. Acts as both a cross-linker and catalyst due to its tertiary amine group.
Applications: Flexible foams, coatings, adhesives.
Benefits: Balances flexibility and cross-linking; accelerates curing.

### 4. Diethanolamine (DEA)

OH Groups: 2 (diol, but often used in triol-like roles)
Description: While technically a diol, it is included as a related amine-based cross-linker often used alongside triols/tetrols to adjust cross-link density.
Applications: Foams, elastomers, coatings.
Benefits: Enhances reactivity and processing.

### 5. Pentaerythritol

OH Groups: 4 (tetrol)
Description: A non-amine tetrol, included as a related high-functionality cross-linker. Provides dense cross-linking without amine catalysis.
Applications: Protective coatings, rigid foams, composites.
Benefits: High thermal and chemical resistance.

### 6. Ethoxylated Pentaerythritol

OH Groups: 4 (tetrol)
Description: Pentaerythritol modified with ethylene oxide for improved solubility and reactivity control.
Applications: Waterborne coatings, flexible foams.
Benefits: Tailored viscosity and flexibility.

### 7. Sorbitol

OH Groups: 6 (hexol)
Description: A high-functionality polyol related to tetrols for very rigid polyurethanes.
Applications: Rigid foams, insulation, structural composites.
Benefits: Maximizes cross-link density for high strength.

### 8. Propoxylated Ethylenediamine

OH Groups: 4 (tetrol)
Description: Ethylenediamine reacted with propylene oxide, similar to quadrol but with varying degrees of propoxylation to adjust properties.
Applications: Rigid foams, elastomers, coatings.
Benefits: Customizable chain length for flexibility or rigidity.

### 9. Trimethylolpropane (TMP)

OH Groups: 3 (triol)
Description: A common triol included as a related cross-linker for moderate cross-linking.
Applications: Coatings, foams, resins.
Benefits: Balances hardness and flexibility.

### 10. Ethoxylated Trimethylolpropane

OH Groups: 3 (triol)
Description: TMP modified with ethylene oxide for enhanced compatibility and processing.
Applications: Flexible foams, waterborne coatings.
Benefits: Improved solubility and controlled reactivity.

Applications: Amine-based tetrols are favored in rigid foams and coatings, while ethoxylated variants suit waterborne or flexible systems.

In one embodiment, the usage level of the cross linkers is in the range of from about 0.5% to about 10%. In one embodiment, the usage level as weight percent of the total mixture is one of the following numbers, or a number within a range formed by any two numbers below, including the endpoints of such ranges: 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, 10.0.

In a preferred embodiment, the usage level is in the range of from about 1% to 5%, by weight of the mixture. In one embodiment, because high-functionality cross-linkers like quadrol may shorten pot life, the curing conditions are adjusted accordingly.

### EXPERIMENTAL

### Process for Preparing High-Flex Modulus Polyurethane

The list of chemical components used for experimental work are provided in Table 2.

As a baseline, in the first experiment, a long chain polyol (4800 MW EO capped polyol), and a 732 MW sucrose bases polyol, and one crosslinker (PolyG-37-600) were used. The flex modulus for this polyurethane was low.

In the second experiment, the long-chain polyol was reduced in concentration and eventually eliminated and replaced with a second crosslinker (292 MW ethylene diamine tetrol) as well as a chain extender (DEG) to maximize the flex modulus.

### Method for B-Side Component

In a clean vessel the following components where added:
1. 732 molecular weight sucrose-based polyol.
2. BYK 410.
3 Voranol 220-260.
4. Pluracol 1578.
5. 292 mw ethylene diamine tetrol.
6. Diethylene glycol
7. Poly-G 37-600
8. Rdf #1

The eight components were mixed until the mixture composition was rendered homogeneous. Components 9 and 10, listed below, were added to the homogeneous mixture.
9. Toyocat DM-70
10. Coscat 83

Component 11 was then added to the above mixture:
11. P6000 burlith paste

The composition was mixed until it was rendered into a homogeneous mixture, and the final product was vacuumed.

The polymeric composition yielded a high polyurethane flex modulus of approximately 450,000 psi when ran at 1:1 ratio by volume with specific diisocyanato A-component.

In another embodiment, the PU flex modulus is 490 KPSI. In yet another embodiment, the flex modulus of the PU material of the present technology is any one of the numbers below and any number within a range defined by any two numbers below, including the endpoints, and as measured in KPSI:
400, 410, 420, 430, 440, 450, 460, 470, 480, 490, 500, 510, 520, 530, 540, 550, 560, 570, 580, 590, 600, 650, 700, and 800.

TABLE 2
List of chemical components used in the experiments

| | | | | | Weight |
|---|---|---|---|---|---|
| | | | Physical | Company | range |
| Component | Chemical name | Formula | characteristics | Source | (%) |
| 732 MW | poly(propylene oxy)sucrose | C12H14O11—(C3H6O)nH8 | 4.5 functional, | Dow | 25%- |
| Sucrose | | | low viscosity | | 55% |
| based | | | Sucrose/glycerine- | | |
| polyol | | | initiated | | |
| | | | polyether | | |
| | | | polyol. | | |
| 4800 MW | glycerol propoxylate- | C8H22O7 | A glycerin- | Covestro | 0%- |
| EO | block-ethoxylate | | initiated | | 15% |
| Capped | | | ethylene | | |
| triol | | | oxide(EO) | | |
| polyol | | | capped | | |
| | | | propoxylated | | |
| | | | high reactivity | | |
| | | | triol. | | |
| Voranol | Polypropylene glycol | H[OCH(CH3)CH2]nOH | homopolymer | Dow | 13%- |
| 220-260 | | | polyether diol | | 20% |
| | | | with nominal | | |
| | | | MW 425 used | | |
| | | | as a chain | | |
| | | | extender. | | |
| Pluracol | Benzenediamine, ar-methyl-, | C12H20N2O2 | aromatic | BASF | 10%- |
| 1578 | polymer with 2-methyloxirane | | initiator-based | | 15% |
| | and oxirane | | polyol with | | |
| | | | 395-415 | | |
| | | | hydroxyl | | |
| | | | number. | | |
| 292 MW | N,N,N′,N′-TETRAKIS(2- | [—CH2N[(—CH2CH2O—)x[—CH2CH(CH3)O—]yH]2]2 | an ethylene | Covestro | 7%- |
| ethylene- | HYDROXYLPROPYL)ETHYL- | | diamine- | | 13% |
| diamine | ENEDIAMINE | | initiated. Four- | | |
| tetrol | | | functional | | |
| | | | polyether | | |
| | | | polyol and act | | |
| | | | as cross | | |
| | | | linker. | | |
| DEG | Diethylene glycol | (HOCH2CH2)2O | a clear, | Brenntag | 11%- |
| | | | colorless, and | | 15% |
| | | | odorless liquid | | |
| | | | with a | | |
| | | | moderate | | |
| | | | viscosity. | | |
| POLY- | OXYPROPYLATED | (C4H11NO2•C3H6O)x | a cross-linker, | Monument | 10%- |
| G37-600 | ALIPHATIC | | has nominal | inc. | 30% |
| | AMINE | | MW of 280 | | |
| | | | and is a stable | | |
| | | | liquid that is | | |
| | | | neither volatile | | |
| | | | nor corrosive. | | |
| RDF #1 | 85% polydimethylsiloxane 15% | SIO2 | 100% silicon, | Silpak | 0%- |
| | amorphous silica | | anti-foaming | INC. | 0.02% |
| | | | agent. | | |
| Coscat | bismuth (III) neodecanoate, | C30H57BiO6 | a proprietary | Aurorium | 0.1%- |
| 83 | 60% in neodecanoic acid | | organobismuth | LLC | 0.21% |
| | (15-20% Bi) | | catalyst for | | |
| | | | surface cure. | | |
| Jeffcat | Bis(2-dimethylaminoethyl) | C12H27NO | amine cross- | Huntsman | NA |
| ZF-10 | ether | | linking | | |
| | | | catalyst. | | |
| Toycat | (70%) 1,2- | C₅H₈N₂ | strong amine | Evonik | 1%- |
| DM-70 | Dimethylimidazole/(30%) | | gelling | | 1.5% |
| | ethylene glycol | | catalyst. | | |
| P6000 | | | Mixture of | IMCD/ET | 3%- |
| | | | moisture | HORN | 6% |
| | | | scavenger | | |
| | | | and castor oil. | | |
| BYK410 | (30%-60%) 1-Methyl-2- | | Liquid | | 0.5%- |
| | pyrrolidone/Lithium | | rheology | | 0.9% |
| | chloride | | additive for | | |
| | | | medium- | | |
| | | | polarity | | |
| | | | solvent-borne | | |
| | | | and solvent- | | |
| | | | free system. | | |

When ranges are used herein for physical properties, such as molecular weight, or chemical properties, such as chemical formulae, all combinations, and subcombinations of ranges for specific embodiments therein are intended to be included.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

1. A composition for polyurethane coating for the inner surface of pipes, wherein the composition is prepared from components comprising:
a polyol component;
an isocyanate component that reacts with polyol to form a tough, cross-linked polyurethane structure;
two or more cross-linking agents to increase the flexural modulus of the resulting coating, wherein the total of —OH groups on the two or more cross-linking agents is six or more.

2. The composition as recited in claim 1, wherein the cross-linking agents include amine-based polyols or polyfunctional alcohols with three or more OH groups.

3. The composition as recited in claim 1, wherein the cross-linking agents are derived from ethylenediamine or similar amines through alkoxylation, for example, with propylene oxide and/or ethylene oxide.

4. The composition as recited in claim 1, wherein the cross-linking agents comprise at least any two of N,N,N′,N′-tetrakis(2-hydroxypropyl)ethylenediamine (Quadrol, EDTP); N,N,N′,N′-tetrakis(2-hydroxyethyl)ethylenediamine (THEED); triethanolamine; (TEA) diethanolamine (DEA); pentaerythritol; ethoxylated pentaerythritol; sorbitol; propoxylated ethylenediamine; trimethylolpropane (TMP); and ethoxylated trimethylolpropane.

5. A polymeric composition prepared by reacting the compositions as recited in claim 1.

6. The polymeric composition as recited in claim 5, wherein the polymeric composition is characterized as having a flexural modulus in the range of from about 400 KPSI to about 800 KPSI.

7. The polymeric composition as recited in claim 5, further comprising one or more additives to enhance chemical stability, chemical resistance, and abrasion resistance as described herein.

8. A method for applying a polyurethane coating to an inner surface of a pipe or conduit, comprising:
mixing polyol and isocyanate components to form a mixture;
applying the mixture to the inner surface;
allowing the coating to cure to form a durable, seamless protective layer.

9. The method recited in claim 8, wherein the polyurethane composition is as recited in claims 5-7.

10. A polyurethane coating as recited in claims above, wherein the PU with the high flexural modulus of at least (400,000 PSI), provides resistance to bending and deformation under environmental stresses.

11. A pipe or conduit coated fully or partially on the inside with the polyurethane coating of claim 10.

1. The pipe or conduit as recited in claim 11, wherein the pipe or conduit is a culvert pipe.

13. The composition as recited in claim 1, wherein the polyol component comprises a sucrose-based polyol having a molecular weight in the range of from about 500 to about 1000.

14. The composition as recited in claim 13, wherein the sucrose-based polyol has a functionality of from about 3 to about 6.

15. The composition as recited in claim 1, wherein the polyol component comprises a sucrose-based polyol present in an amount in the range of from about 25% to about 55% by weight of the composition.

16. The composition as recited in claim 15, wherein the sucrose-based polyol is present in an amount in the range of from about 27% to about 35% by weight of the composition.

17. The composition as recited in claim 1, wherein the two or more cross-linking agents comprise a 292 MW ethylene diamine tetrol and Poly-G 37-600.

18. The composition as recited in claim 17, wherein the 292 MW ethylene diamine tetrol is N,N,N′,N′-tetrakis(2-hydroxypropyl)ethylenediamine.

19. The composition as recited in claim 17, wherein the 292 MW ethylene diamine tetrol is present in an amount in the range of from about 7% to about 13% by weight of the composition.

20. The composition as recited in claim 19, wherein the 292 MW ethylene diamine tetrol is present in an amount of about 12% by weight of the composition.

21. The composition as recited in claim 17, wherein the Poly-G 37-600 is present in an amount in the range of from about 10% to about 30% by weight of the composition.

22. The composition as recited in claim 21, wherein the Poly-G 37-600 is present in an amount in the range of from about 10% to 20% based on weight of the composition.

23. The composition as recited in claim 1, further comprising a chain extender.

24. The composition as recited in claim 23, wherein the chain extender comprises diethylene glycol.

25. The composition as recited in claim 24, wherein the diethylene glycol is present in an amount in the range of from about 10% to about 16% by weight of the composition.

26. The composition as recited in claim 25, wherein the diethylene glycol is present in an amount of about 13% to about 15% by weight of the composition.

27. The composition as recited in claim 1, further comprising a polyether diol chain extender having a molecular weight in the range of from about 200 to about 600.

28. The composition as recited in claim 27, wherein the polyether diol chain extender comprises Voranol 220-260 present in an amount in the range of from about 13% to about 20% by weight of the composition.

29. The composition as recited in claim 1, further comprising an aromatic initiator-based polyol having a hydroxyl number in the range of from about 395 to about 415.

30. The composition as recited in claim 29, wherein the aromatic initiator-based polyol comprises Pluracol 1578 present in an amount in the range of from about 10% to about 15% by weight of the composition.

31. A composition for preparing a polyurethane coating on an inner surface of pipes or conduits, wherein the composition is prepared from a B-side component and an A-side component, wherein the B-side component comprises:
a sucrose-based polyol having a molecular weight in the range of from about 700 to 800;
an ethylene diamine tetrol having a MW in the range of from about 200 to 400;
an oxypropylated aliphatic amine cross-linker;
a diethylene glycol as a chain extender;
a polyether diol chain extender;
an aromatic initiator-based polyol;
one or more catalysts; and
an anti-foaming agent;
wherein the A-side component comprises a polymeric MDI having a functionality in the range of from about 2.5 to about 3.0.

32. The composition as recited in claim 31, wherein the B-side component and the A-side component are present in a ratio by volume of about 1 to 1.

33. The composition as recited in claim 31, wherein the B-side component is present in an amount in the range of from about 45% to about 55% by weight of the total composition.

34. The composition as recited in claim 31, wherein the A-side component is present in an amount in the range of from about 45% to about 55% by weight of the total composition.

35. The composition as recited in claim 31, wherein the composition has an isocyanate index in the range of from about 0.85 to about 1.10.

36. The composition as recited in claim 31, further comprising a rheology additive.

37. The composition as recited in claim 36, wherein the rheology additive comprises BYK 410 present in an amount in the range of from about 0.5% to about 0.9% by weight of the B-side component.

38. The composition as recited in claim 31, wherein the one or more catalysts comprise an organobismuth catalyst.

39. The composition as recited in claim 38, wherein the organobismuth catalyst comprises bismuth (III) neodecanoate present in an amount in the range of from about 0.1% to about 0.21% by weight of the B-side component.

40. The composition as recited in claim 31, wherein the one or more catalysts comprise an amine gelling catalyst.

41. The composition as recited in claim 40, wherein the amine gelling catalyst comprises 1,2-dimethylimidazole present in an amount in the range of from about 1% to about 1.5% by weight of the B-side component.

42. The composition as recited in claim 31, further comprising a moisture scavenger.

43. The composition as recited in claim 42, wherein the moisture scavenger is present in an amount in the range of from about 3% to about 6% by weight of the B-side component.

44. The composition as recited in claim 31, wherein the composition has a gel time at about 74 °F in the range of from about 10 seconds to about 40 seconds.

45. The composition as recited in claim 31, wherein the B-side component has a viscosity at about 75 °F in the range of from about 600 cps to about 900 cps.

46. A cured polyurethane coating prepared from the composition as recited in claim 31, wherein the cured coating has a Shore D hardness in the range of from about 80 to about 90.

47. The cured polyurethane coating as recited in claim 46, wherein the cured coating has an average flexural strength in the range of from about 9 KSI to about 16 KSI.

48. A method for preparing a B-side component for making a high flexural modulus polyurethane coating, comprising:
adding to a clean vessel a sucrose-based polyol, a rheology additive, a polyether diol chain extender, an aromatic initiator-based polyol, an ethylene diamine tetrol, diethylene glycol, an oxypropylated aliphatic amine cross-linker, and an anti-foaming agent;
mixing the components until homogeneous to form a mixture;
adding one or more catalysts to the mixture;
adding a moisture scavenger to the mixture; and
mixing and vacuuming the mixture to form the B-side component for making a high flexural modulus polyurethane coating.

49. The method as recited in claim 48, wherein the sucrose-based polyol has a molecular weight in the range of from about 500 to about 1000, and is present in an amount in the range of from about 25% to about 55% by weight in the mixture.

50. The method as recited in claim 48, wherein the ethylene diamine tetrol has a molecular weight of about 292 and is present in an amount in the range of from about 7% to about 13% by weight in the mixture.

51. The method as recited in claim 48, wherein the one or more catalysts comprise an organobismuth catalyst and an amine gelling catalyst.

52. A pipe and conduit rehabilitation system, comprising:
an A-side component comprising an isocyanate component;
a B-side component comprising a polyol component and two or more cross-linking agents, wherein a total of —OH groups on the two or more cross-linking agents is six or more; and
wherein the A-side component and the B-side component are configured to be mixed to polymerize and form a cured polyurethane coating on an inner surface of an installed pipe or conduit, wherein the cured polyurethane coating has a flexural modulus in a range of from about 400 KPSI to about 800 KPSI.

53. The pipe and conduit rehabilitation system as recited in claim 52, further comprising a plural-component applicator configured to dispense the A-side component and the B-side component and mix the A-side component and the B-side component at a volumetric ratio of about 1:1 for application to the inner surface.

54. The composition as recited in claim 1, wherein the composition is a 100% solids polyurethane composition.

55. The composition as recited in claim 1, wherein the cured coating has a thickness in the range of from about 50 mils to about 500 mils.

56. The pipe and conduit rehabilitation system as recited in claim 52, wherein the pipe or conduit comprises a material selected from the group consisting of corrugated steel, corrugated plastic, and reinforced concrete.

57. The pipe and conduit rehabilitation system as recited in claim 52, wherein the pipe or conduit has a diameter of at least 10 feet.

58. The cured polyurethane coating as recited in claim 46, wherein the cured coating provides resistance to flexural fatigue under cyclic loading conditions.

59. The composition as recited in claim 1, wherein the composition is formulated as a spray elastomer coating.

60. The method as recited in claim 8, wherein the coating is applied at a thickness that is reduced by at least 25% compared to conventional polyurethane coatings while maintaining equivalent or superior flexural performance.

61. The pipe and conduit rehabilitation system as recited in claim 52, wherein the cured polyurethane coating forms a seamless protective layer on the inner surface of the pipe or conduit.

62. The composition as recited in claim 31, wherein the cured composition exhibits thermal stability under temperature variations encountered in underground pipe installations.

63. The method as recited in claim 48, further comprising combining the B-side component with an A-side component comprising a polymeric MDI at a ratio by volume of about 1:1 to form the polyurethane coating composition.

64. The polymeric composition as recited in claim 6, wherein the flexural modulus is in the range of from about 400 KPSI to 500 KPSI.

65. The method of claim 8, wherein the step of applying the mixture to the inner surface of the pipe or conduit uses manual or robotic 1:1 plural high-pressure spray equipment.

66. The method of claim 8, wherein the mixture comprises:
a polyol component;
an isocyanate component that reacts with polyol to form a tough, cross-linked polyurethane structure; and
two or more cross-linking agents to increase the flexural modulus of the resulting coating, wherein the total of —OH groups on the two or more cross-linking agents is six or more.
